(19) United States
(12) Patent Application Publication
(10) Pub. No.: US 2026/0328366 A1
(43) Pub. Date: Oct. 22, 2026

(54) LIGHTING DEVICE FOR PROJECTING AN IMAGE ONTO THE GROUND AROUND A VEHICLE

(71) Applicant: VALEO VISION, Bobigny (FR)

(72) Inventors: Sidahmed BEDDAR, Bobigny (FR); Rabih TALEB, Bobigny (FR); Remi LETOUMELIN, Bobigny (FR)

(73) Assignee: VALEO VISION, Bobigny (FR)

(21) Appl. No.: 19/108,909

(22) PCT Filed: Sep. 7, 2023
(86) PCT No.: PCT/EP2023/074685

§ 371 Date: Mar. 5, 2025

(30) Foreign Application Priority Data
Sep. 7, 2022 (FR) 2208932

(51) Int. Cl. F21S 43/00; B60Q 1/32; B60Q 1/50; F21W 103/60

(52) U.S. Cl. CPC F21S 43/601; B60Q 1/32; B60Q 1/50; B60Q 1/543; B60Q 2400/50; F21W 2103/60

(57) ABSTRACT

The invention relates to a lighting device for a motor vehicle, for projecting an image onto the ground around the motor vehicle. The lighting device includes a light source, a slide provided with at least one pattern, and at least one screen provided with an opaque area. The screen being movable between a first position and a second position relative to the slide. The opaque area of the screen extending outside of a light beam coming from the slide when the screen is in its first position to project a first image onto the ground, and the opaque area of the screen extending across the light beam coming from the slide when the screen is in its second position to project a second image onto the ground, with the second image is different from the first image.

### TECHNICAL FIELD

The invention relates to a luminous device for an automotive vehicle, the luminous device being configured to project an image such as a pictogram onto the ground. The invention also relates to a method for operating such a luminous device.

### BACKGROUND OF THE INVENTION

Some automotive vehicles are equipped with a luminous device configured to project an image onto the ground around the vehicle. These luminous devices comprise a light source and a slide lit up by the light source. A light beam from the slide is directed toward the ground around the vehicle. The images thus projected may include pictograms intended to provide useful information to a user. For example, when the vehicle is a plug-in electric or hybrid vehicle, the image projected onto the ground can provide an indication of the level of charge of a vehicle battery. A pictogram representing the level of charge of a battery may conventionally include the schematic depiction of a battery cell with various stages, these stages being depicted full or empty depending on the level of charge.

In order to enhance the visual effect and the quality of the information transmitted to the user, it is desirable to animate the images projected onto the ground. For example, in a pictogram representing the level of charge of a battery, a stage can be depicted flashing to indicate that the battery is charging. In order to animate the image projected onto the ground, luminous devices equipped with a slide in the form of a disk, the orientation of which is controlled by an electric motor, are known. The slide includes several patterns distributed over various sectors, and intended to be selectively lit up by the light source depending on the orientation of the slide. Such a solution therefore makes it possible to change the image projected by rotating the slide. This makes it possible to produce an animation, in particular a flashing effect of the image projected onto the ground.

However, this solution has disadvantages. To be specific, precise orientation of the slide requires the use of a complex electric motor. When a simpler electric motor is used, the orientation of the slide is less precise. This has the effect that the successive images projected onto the ground may be spatially offset from one another to a significant degree. This offset is particularly noticeable when the images successively projected have elements in common. Thus, the visual rendering of a pictogram comprising fixed elements and flashing elements is particularly poor with the luminous devices known from the prior art.

The luminous devices known from the prior art also have the disadvantage of requiring a slide that is large in order to fit the various patterns thereon. The space taken up by the luminous device is thus increased and becomes incompatible with integration in locations on the vehicle where the space available is small, such as at an exterior rear-view mirror or at a door sill of the vehicle. Reducing the dimensions of the patterns on the slide results in the projection of images that are too small and/or blurred.

### SUMMARY OF THE INVENTION

The aim of the invention is to provide a luminous device and a method for using such a luminous device that remedy the above drawbacks and improve the luminous devices known from the prior art and their method for use.

More specifically, a first subject of the invention is a luminous device which is both simple and allows a pictogram to be projected with optimal visual rendering.

A second subject of the invention is a method for using a luminous device making it possible to animate a pictogram with optimal visual rendering

The invention relates to a luminous device for projecting an image onto the ground around an automotive vehicle, the luminous device comprising:
a light source,
a slide provided with at least one pattern, the at least one pattern being arranged in such a way as to be lit up by the light source, and
at least one mask provided with an opaque zone, the mask being movable between a first position and a second position relative to the slide,
the opaque zone of the mask not extending across a light beam coming from the slide when the mask is in its first position so as to project a first image onto the ground, and
the opaque zone of the mask extending across the light beam coming from the slide when the mask is in its second position so as to project a second image onto the ground that is different to the first image.

The luminous device may comprise a first stop means defining the first position of the mask and/or a second stop means defining the second position of the mask.

The luminous device may comprise an actuator configured to move the mask in translation between its first position and its second position.

Said actuator may comprise an electromagnet, and the mask may comprise an element made of ferromagnetic material configured to interact with the electromagnet. Said actuator may comprise a motor provided with a pinion, the mask comprising teeth interacting with said pinion.

The at least one pattern of the slide may comprise at least one opaque zone and at least one transparent zone, the opaque zone of the mask comprising a shape substantially homothetic to the shape of the at least one transparent zone of the slide to occult the at least one transparent zone of the slide when the mask is in its second position.

The at least one pattern of the slide may comprise an opaque zone, a first transparent zone, and a second transparent zone, the second transparent zone being separated from the first transparent zone by the opaque zone of the slide, the mask comprising a transparent zone extending opposite the first transparent zone of the slide and the opaque zone of the mask extending opposite the second transparent zone of the slide when the mask is in its second position.

The luminous device may comprise:
a first mask provided with an opaque zone, the first mask being movable between a first position and a second position relative to the slide, and
at least one second mask provided with an opaque zone, the second mask being movable between a first position and a second position relative to the slide,
the opaque zone of the first mask and the second mask not extending across a light beam coming from the slide when the first mask and the second mask are in their first position so as to project a first image onto the ground,
the opaque zone of the first mask extending across the light beam coming from the slide when the first mask is in its second position and the second mask is in its first position so as to project a second image onto the ground that is different to the first image, and the opaque zone of the second mask extending across the light beam coming from the slide when the second mask is in its second position so as to project a third image onto the ground that is different to the first image and the second image.

The slide may comprise a first pattern and at least one second pattern, and the slide may be movable between a first position and a second position, the first pattern being arranged in such a way as to be lit up by the light source when the slide is in its first position, the second pattern being arranged in such a way as to be lit up by the light source when the slide is in its second position, the luminous device being adapted to project a first image onto the ground when the slide is in its first position, and the luminous device being adapted to project a fourth image onto the ground when the slide is in its second position.

The slide may have a generally circular shape, and the luminous device may comprise an actuator configured to rotate the slide between its first position and its second position about a center of the slide.

The invention also relates to a method for operating a luminous device as defined above, the operating method comprising a movement of the at least one mask from its first position to its second position then a movement of the at least one mask from its second position to its first position to produce a flashing effect of the image projected onto the ground.

### BRIEF DESCRIPTION OF DRAWINGS

These subjects, features and advantages of the present invention will be set forth in detail in the following description of a particular embodiment given by way of non-limiting example in conjunction with the accompanying figures, in which:

FIG. 1 is a schematic view of an automotive vehicle equipped with a luminous device according to an embodiment of the invention.

FIG. 2 is a schematic view of a slide of the luminous device.

FIG. 3 is a schematic view of a first mask of the luminous device.

FIG. 4 is a schematic view of a second mask of the luminous device.

FIG. 5 is a schematic top view of the vehicle and a first image projected by the luminous device next to the vehicle.

FIG. 6 is a schematic top view of the vehicle and a second image projected by the luminous device next to the vehicle.

FIG. 7 is a schematic top view of the vehicle and a third image projected by the luminous device next to the vehicle.

### DETAILED DESCRIPTION OF THE INVENTION

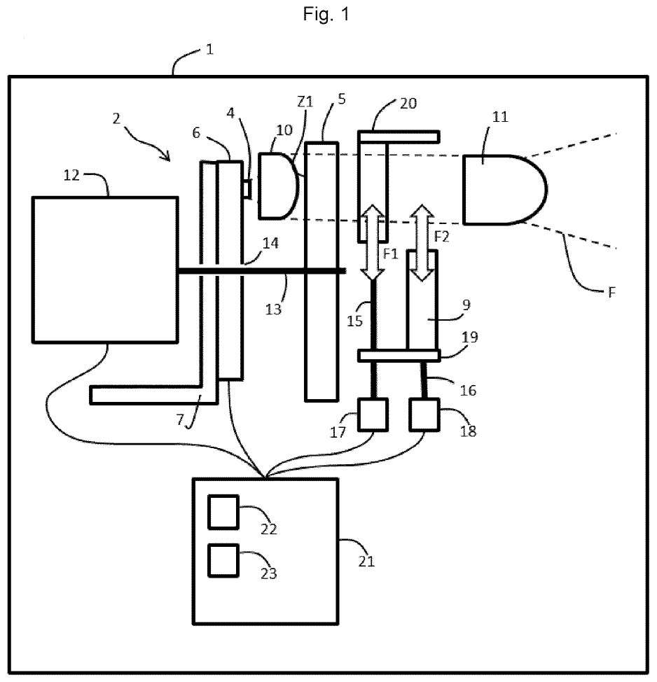

FIG. 1 schematically depicts an automotive vehicle 1 according to an embodiment of the invention. The vehicle 1 may be, for example, a passenger vehicle, a utility vehicle, a truck or even a bus. The vehicle 1 comprises a luminous device 2 according to an embodiment of the invention. The luminous device 2 is configured to project an image onto the ground around the vehicle 1. The image may be projected onto the ground at a few dozen centimeters along one side of the vehicle, for example. The luminous device 2 may be, for example, attached to the vehicle at an exterior rear-view mirror of the vehicle or at a door sill of the vehicle.

The luminous device 2 comprises at least one light source 4 adapted to produce a light beam F and a slide 5 positioned on the path of the light beam F. The slide 5 comprises at least one pattern configured to modify the light beam coming from the light source 4 in such a way as to project an image onto the ground. In particular, the slide 5 is configured to intercept or filter certain light rays coming from the light source 4 in such a way as to produce an image. Note that the luminous device 2 is not intended to produce night-time lighting of the vehicle's surroundings, or to make the vehicle clearly visible to other road users. Thus, the luminous device 2 is distinguished from the headlights which are usually fitted to vehicles and which have high beam lights and/or low beam lights. The image projected onto the ground may include information on the status of the vehicle and/or on the vehicle's surroundings. Advantageously, the image projected onto the ground takes the form of one or more pictograms.

The light source 4 may be, for example, a light-emitting diode or a set of light-emitting diodes. Alternatively, it could take any other form, such as an incandescent light bulb. Advantageously, the light source may have sufficient power to project an image onto the ground that is visible even in broad daylight. Preferably, the light source 4 may project white light rays. The light source 4 may be connected to a printed circuit board 6. The printed circuit board may be held by a support 7 possibly comprising a heat sink.

The luminous device 2 also comprises two masks 8, 9 each comprising at least one opaque zone. Each mask 8, 9 is movable independently of the other between a first position and a second position. The opaque zone of each mask does not extend across a light beam F coming from the slide when the mask is in its first position, and the opaque zone of each mask extends across the light beam F coming from the slide when the mask is in its second position. The first position of each mask is therefore a retracted position and the second position is a masking position. A first mask 8 is positioned directly downstream of the slide 5, according to the direction of propagation of the light rays, at least when it is in its second position. A second mask 9 is positioned directly downstream of the first mask 8, according to the direction of propagation of the light rays, at least when it is in its second position. FIG. 1 shows the first mask 8 in its second position and the second mask 9 in its first position. Arrows F1 and F2 respectively represent the movement of the masks 8 and 9 between their first and second positions. Alternatively, the luminous device could comprise a single mask or three masks or even more masks positioned downstream of one another, according to the direction of propagation of the light rays, at least when they are in their second position.

The luminous device 2 also comprises an optical guide 10 arranged between the light source 4 and a portion of the slide 5. The optical guide 10, or light guide, is configured to guide the light rays coming from the light source 4 toward a portion of the slide 5. Thus, according to the embodiment presented, the luminous device 2 comprises a slide 5 lighting zone Z1, and only the part of the slide 5 positioned in the lighting zone Z1 contributes to the projection of an image onto the ground. An optical element 11, such as a projection lens, may be provided downstream of the masks 8, 9, that is to say on the other side of the slide 5 and the masks 8, 9 relative to the light source 4, in order to shape and direct the light beam toward the ground.

According to a simplified embodiment, the slide 5 could be fixed in position within the luminous device 2. According to a preferred embodiment, the slide 5 comprises at least two patterns, and it is movable between a first position and at least one second position, distinct from the first position. When the slide is in its first position, a first pattern is positioned in the lighting zone Z1. When the slide is in its second position, a second pattern is positioned in the lighting zone Z1. To move the slide 5 between its first position and its second position, the luminous device 2 comprises a first actuator 12 mechanically connected to the slide 5. Advantageously, the plane in which the slide 5 extends in its first position may be identical to the plane in which it extends in its second position. In particular, the slide 5 may advantageously be rotatable about an axis perpendicular to the plane in which it extends. Alternatively or in combination, the slide 5 could also be movable in translation in the plane in which it extends.

According to a preferred embodiment, the first actuator 12 is an electric motor. The electric motor is positioned behind the printed circuit board 6 and behind the support 7. It comprises a rotary shaft 13 passing through an opening 14 made in the printed circuit board 6 and in the support 7. The slide 5 has a circular shape and is attached at its center O to the rotary shaft 13. The various patterns on the slide 5 are distributed across different angular sectors of the slide.

According to an alternative embodiment, the connection between the first actuator 12 and the slide 5 could be arranged differently. For example, the slide 5 could be rotatably or slidably mounted on a support distinct from the first actuator 12. The first actuator could be mechanically connected to an edge of the slide 5. A translational and/or rotational movement of the slide 5 could be obtained by virtue of the interaction between a toothed wheel rigidly secured to the first actuator and a rack rigidly secured to the slide 5.

Preferably, each mask 8, 9 is movable in translation between its first position and its second position. For this purpose, the masks 8, 9 may each be mounted in sliding connection on a rod 15, 16. In particular, the masks may be movable in translation along an axis perpendicular to the rotary shaft 13. Alternatively, other types of motion for moving the masks between their first position and their second position could be envisaged, such as a rotational motion or a combination of a rotation and a translation. In any case, the plane in which each mask extends in its first position may be identical to the plane in which it extends in its second position.

To move each of the masks 8 and 9 between their first position and their second position, the luminous device 2 also comprises as many actuators 17, 18 as there are masks, each actuator being mechanically connected to a mask. According to an embodiment, an actuator 17, 18 comprises an electromagnet, and the corresponding mask 8, 9 comprises an element made of ferromagnetic material configured to interact with the electromagnet. When the electromagnet is activated by the passage of an electric current, it exerts a force which tends to move the mask 8, 9 concerned along its rod 15, 16 toward its second position or toward its first position. Such an embodiment may optionally be supplemented by a return means such as a spring acting in the opposite direction to the electromagnet. According to another alternative embodiment of the invention, an actuator 17, 18 may comprise a motor provided with a pinion, and the mask may comprise teeth interacting with said pinion.

Note that the actuators 12, 17 and 18 only move the slide 5, the first mask 8 and the second mask 9, respectively. Since the slide and the masks are very light, these actuators 12, 17, 18 may be particularly simple and compact.

Advantageously, the luminous device comprises a first stop means 19 defining the first position of each mask and/or a second stop means 20 defining the second position of each mask. In other words, each mask 8, 9 bears against the first stop means 19 when it is in its first position, and against the second stop means 20 when it is in its second position. These stop means 19, 20 may be arranged at two opposite ends of the rods 15, 16. They may be formed by mechanical bearing means on an edge of each mask 8, 9. Thus, the actuators 17, 18 do not necessarily have to be designed such that they move the masks 8, 9 with great precision. On the contrary, they may have a very simple design. The first position and second position of each mask is nevertheless established with great precision.

The printed circuit board 6 and the three actuators 12, 17 and 18 are electrically connected to an electronic control unit 21 comprising a memory 22 and a microprocessor 23. The memory 22 of the electronic control unit 21 is a data recording medium on which is recorded a computer program comprising program code instructions for implementing a method for automatic control of the luminous device 2. In particular, the electronic control unit 21 is configured to control switching on or off of the light source 4 as well as activation of the actuators 12, 17 and 18. The electronic control unit 21 may therefore control the orientation of the slide 5 as well as the position of each mask 8, 9. The microprocessor 23 is adapted to execute this computer program.

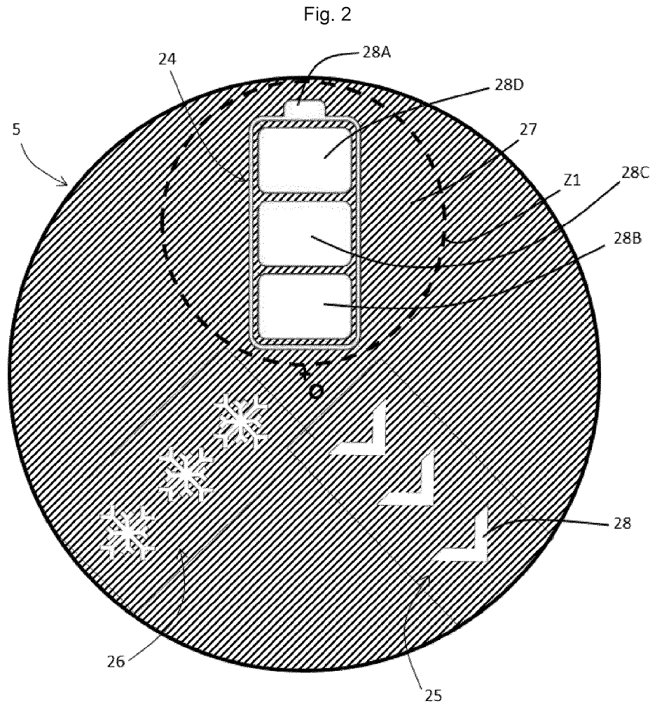

FIG. 2 illustrates an embodiment of the slide 5. The slide 5 forms a screen extending in a plane substantially perpendicular to the light beam F. It has the shape of a disk and is rotatable about an axis passing through the center O of the disk. Such an embodiment has the advantage that the volume taken up by the slide 5 does not vary depending on its orientation. The luminous device 2 may therefore be very compact. The diameter of the disk may be, for example, between 1 cm and 5 cm inclusive.

According to the embodiment presented, the slide comprises three patterns 24, 25, 26, the lighting of which by the light source makes it possible to project three distinct images onto the ground. The patterns 24, 25, 26 are distributed around the center O. The patterns are distributed such that only one pattern at a time may be in the lighting zone Z1. Note that the lighting zone Z1 has a circular shape. Alternatively, the lighting zone could have any other shape, such as for example a generally polygonal shape, in particular a generally trapezoidal or pseudo-trapezoidal shape, the optical guide 10 then being adapted accordingly. Alternatively, the slide could include a single pattern, only two patterns, or any number of patterns greater than or equal to four.

According to an embodiment, the patterns 24, 25, 26 each comprise opaque zones 27 and transparent zones 28. The opaque zones 27 (shown as a hatched surface in FIG. 2) are zones that block or reflect the light rays coming from the light source 4. They may be, for example, black or chrome. The transparent zones 28 are zones that allow the light rays coming from the light source 4 to pass through. The opaque zones 27 and the transparent zones 28 are complementary zones on the surface of the slide 5. For example, the slide 5 may comprise a transparent support, for example made of glass, locally covered by an occulting substrate deposited by lithography. Lithography advantageously makes it possible to obtain high geometric precision in the transparent zones and opaque zones. Alternatively, other methods could be envisaged, such as cutting openings in a support made of opaque material, in particular by laser cutting. According to an alternative embodiment, the patterns 24, 25, 26 could comprise translucent zones in such a way as to produce an image projected onto the ground comprising portions of variable luminous intensity. The slide could also include colored filters to produce a color image.

The transparent zones 28 have shapes, in particular contours, suitable for the projection onto the ground of images representing a pictogram. The contours of each transparent zone 28 are therefore linked to the contours of the pictogram. In practice, the shape of the transparent zones 28 may be adapted to take into account the geometric deformations linked to the projection of the light beam on the ground, in particular to take into account the angle of incidence of the light rays on the ground. A first pattern 24 may comprise the shape of a battery cell comprising three stages, each stage representing a level of charging of the battery. In particular, the first pattern 24 comprises four distinct transparent zones 28A, 28B, 28C and 28D. The four transparent zones 28A, 28B, 28C and 28D are separated from one another by opaque zones 27. In this case, the transparent zone 28A represents a contour of the shape of the battery cell and the transparent zones 28B, 28C and 28D each represent a level of the battery cell. A second pattern may include symbols in the shape of an arrow and a third pattern may include symbols in the shape of a snowflake. Alternatively, any other geometric shape, symbol, or pictogram could be envisaged. The largest dimension of a transparent zone 28 may for example be between 1 mm and 10 mm inclusive. The pictogram projected onto the ground preferably has a simple geometric shape. The image projected by the luminous device is non-pixelated.

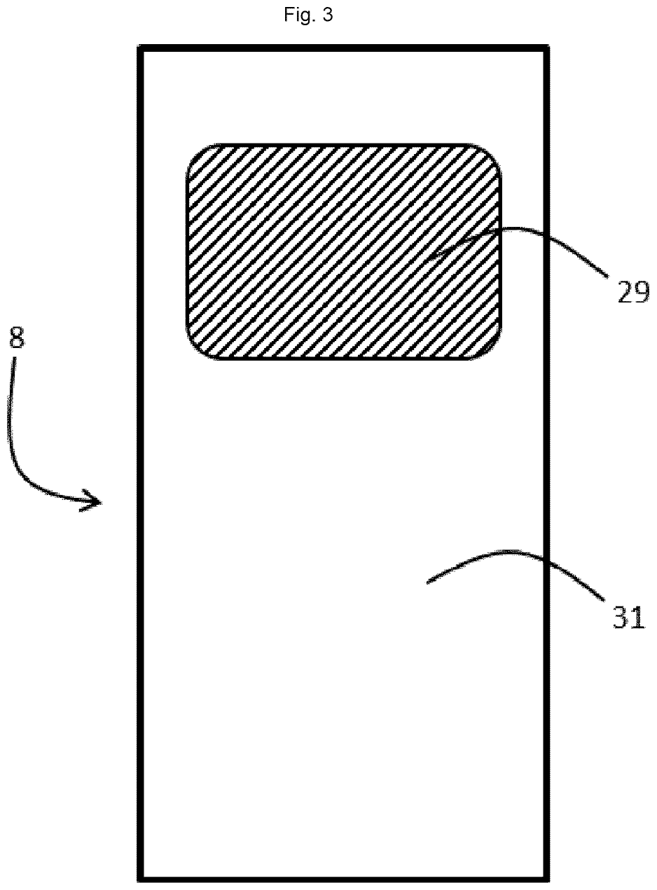

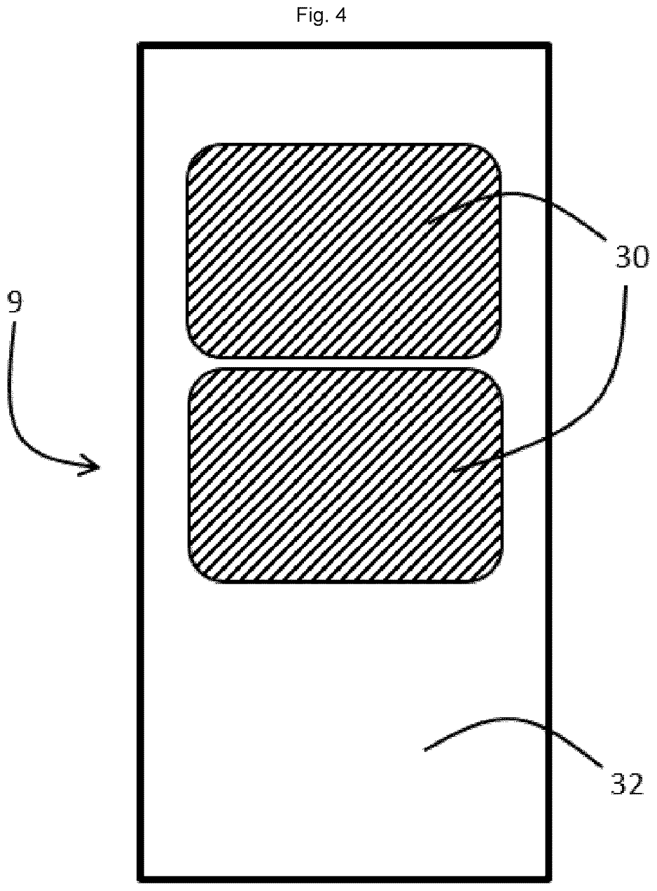

FIGS. 3 and 4 show the first mask 8 and the second mask 9, respectively. Each mask 8, 9 comprises at least one opaque zone 29, 30. The opaque zone 29, 30 of each mask is intended to be positioned opposite a transparent zone of the slide in such a way as to modify the image projected onto the ground. In addition, each mask may also include one or more transparent zones 31, 32. These transparent zones 31, 32 in particular make it possible to support the opaque zones 29, 30 invisibly. The transparent zones 31, 32 may therefore extend between the opaque zones 29, 30 and an interface interacting with the actuators 17, 18. The opaque zones 29, 30 and the transparent zones 31, 32 may be complementary zones on the surface of each mask 8, 9. For example, each mask 8, 9 may comprise a transparent support, for example made of glass, locally covered by an occulting substrate deposited by lithography. Alternatively, the masks 8, 9 could be obtained by cutting openings in a support made of opaque material, in particular by laser cutting.

Advantageously, at least one opaque zone 29, 30 of a mask 8, 9 may comprise a shape substantially homothetic to the shape of at least one transparent zone 28A, 28B, 28C, 28D of the slide 5. This makes it possible to selectively occult the transparent zone 28A, 28B, 28C, 28D concerned without occulting other transparent zones when the mask is in its second position. It is thus possible to eliminate an element forming the pictogram projected onto the ground without modifying or negatively affecting the appearance of the other elements of the pictogram. For example, in the present case, the transparent zones 28C and 28D have substantially rectangular shapes. These rectangular shapes are reproduced by the opaque zones 29 of the masks 8 and 9. Note that, in the event that the light beam coming from the slide is diverging or converging, it is possible to provide shapes of the opaque zones 29, 30 which are not identical but more generally homothetic. As will be seen below, the opaque zones 29, 30 may also be provided with larger dimensions than the transparent zones 28A, 28B, 28C, 28D which they are intended to cover, so as to make an allowance for offsets in terms of positioning between the slide and the mask.

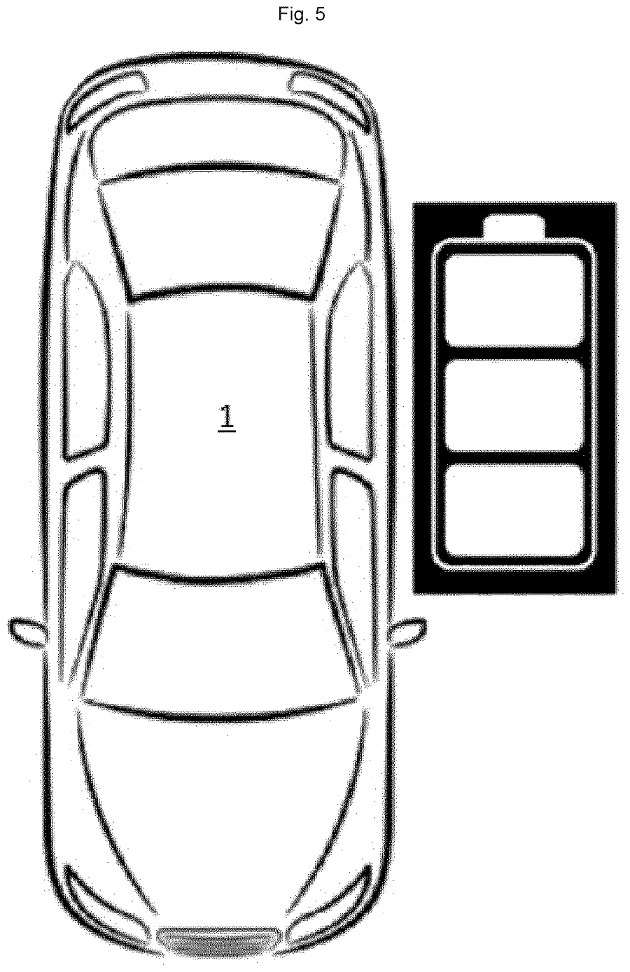

FIG. 5 shows the vehicle 1 and the image projected onto the ground next to the vehicle by the luminous device 2 when the pattern 24 is positioned in the lighting zone Z1 and when the two masks 8 and 9 are in their first position. The light source 4 emits a light beam which is guided by the optical guide 10 and illuminates the slide 5 in the lighting zone Z1. The light rays incident in the opaque zones 27 of the slide are reflected or absorbed and are not projected onto the ground. The light rays incident in the transparent zones 28A, 28, 28C, 28D of the slide pass through the slide and reach the optical element 11 without being blocked by a mask. The light rays are then guided toward the ground by the optical element 11. The resulting image shows a pictogram of a battery cell with all three stages full, indicating that the battery of the vehicle is fully charged.

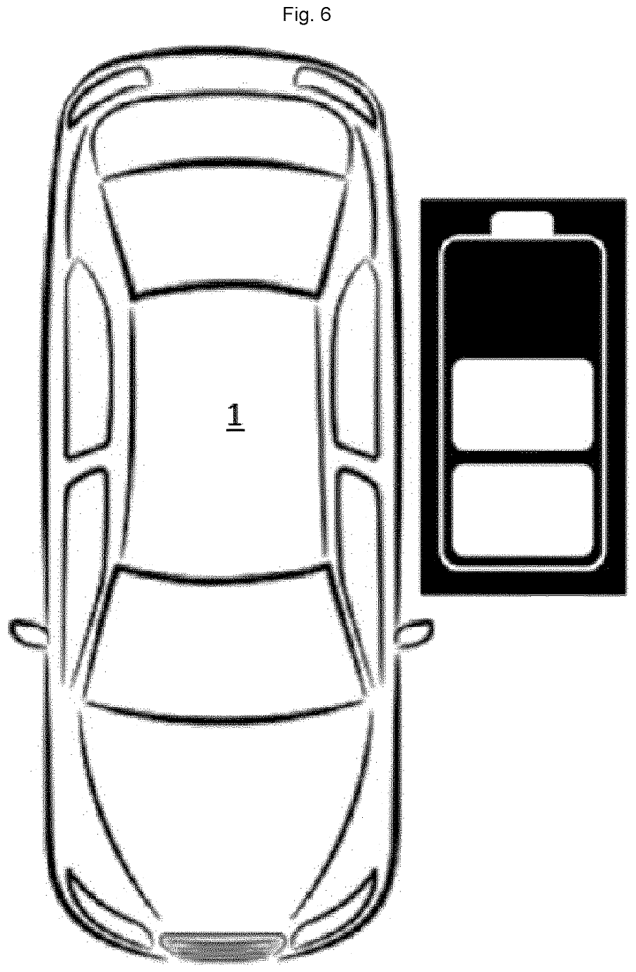

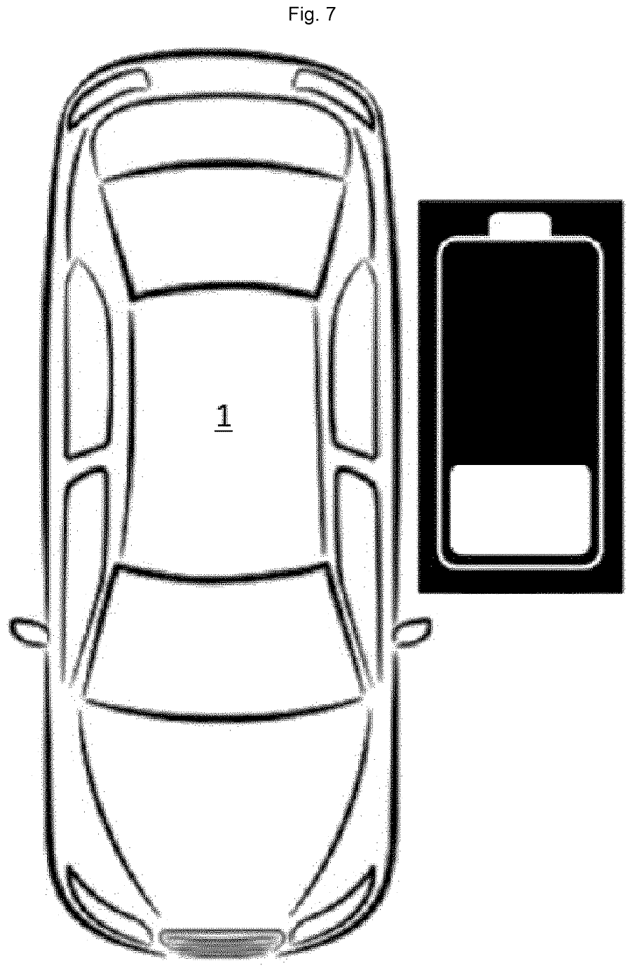

FIG. 6 shows the image projected onto the ground next to the vehicle by the luminous device 2 when the first mask 8 is in its second position and the second mask is in its first position. The opaque zone 29 of the first mask then covers the transparent zone 28D of the first pattern 24, which results in the display of a pictogram of a battery cell with only two stages lit up. Such a pictogram may indicate that the vehicle battery is two-thirds charged. FIG. 7 shows the image projected onto the ground next to the vehicle by the luminous device 2 when the second mask is in its second position. The opaque zone 30 of the second mask then covers the transparent zones 28C and 28D of the first pattern 24, which results in the display of a pictogram of a battery cell with only one stage lit up, which indicates that the vehicle battery is one-third charged.

As the various transparent zones 28A, 28, 28C, 28D are separated from one another by opaque zones 27, the luminous device can tolerate a degree of inaccuracy in the positioning between the slide 5 and the masks 8 or 9. To be specific, the opaque zones 29, 30 of each mask may be offset slightly relative to the transparent zones 28C, 28D which they cover as long as they are large enough to cover the transparent zones 28C, 28D despite the offset, but not too large so as not to protrude into another transparent zone 28A, 28B of the slide. Therefore, the wider the opaque zones 27 separating the different transparent zones 28A, 28B, 28C and 28D of the mask, the more the luminous device will be able to tolerate significant offsets in positioning between the slide and the masks without impairing the quality of the image projected onto the ground.

Advantageously, the opaque zones 29, 30 of the first mask and the second mask do not cover the transparent zone 28A so that the contour of the battery cell is always clearly visible, whatever the position of the masks. Note that, in the case at hand, the second mask comprises two opaque zones corresponding to the two transparent zones 28C and 28D of the first pattern. Alternatively, the second mask could comprise only one opaque zone corresponding only to the transparent zone 28C. In this case, both masks 8 and 9 would have to be in their second position to produce the pictogram shown in FIG. 7. Of course, a larger number of masks could be envisaged, to cover other transparent zones of the slide. For example, the luminous device could comprise a third mask comprising an opaque zone positioned in such a way as to mask the transparent zone 28B and thus produce the pictogram of a battery cell without any stage lit up. For each mask added, the number of different images the luminous device can produce may be doubled. According to another embodiment, the same mask could be movable between more than two positions (for example between three positions or between four positions) and include as many different opaque zones as different positions. For each position of said mask, different transparent zones of the slide would be masked.

By virtue of the invention, it is thus possible to obtain different images projected onto the ground without having to rotate the slide 5. It is thus possible to offer a luminous device in which the slide has fewer patterns on its surface while still having a significant number of different images. Because the slide includes fewer patterns, each pattern may be larger on the slide, improving the resolution of the image projected. Furthermore, the different images obtained are projected onto the ground in substantially the same place. This makes it possible to project a succession of images without seeing any offset between the different images projected.

The electronic control unit 21 may control the position of one or more masks in such a way as to cause the mask to move back and forth between its first position and its second position. This results in a flashing effect of the image projected. The light source may optionally be turned off while the mask is moving in such a way as to mask the transition between the images projected. Conversely, the light source could also be kept on while the mask moves, so as to provide additional animation of the image, a portion of the image being gradually masked or uncovered as the mask moves. Since the slide is stationary while the masks move back and forth, the portions of the image corresponding to the unmasked transparent zones 28A or 28B remain perfectly still relative to the vehicle. The quality of the animation is thus optimal. The flashing state of the image projected onto the ground may indicate that the vehicle battery is charging.

To change the images projected onto the ground, the slide may also be rotated 120° around its center O. Depending on the embodiment illustrated, it is thus possible to obtain the projection of pictograms representing snowflakes, arrows or any other symbol. Advantageously, the masks 8 and 9 may also be used to locally mask the patterns 25 and 26. This makes it possible to obtain the projection of one, two, or even three snowflake symbols on the ground. It also makes it possible to obtain the projection of one, two, or three arrow symbols on the ground. In the same way, it is also possible to animate, in particular by rendering them flashing, the display of all or some of these pictograms.

What is claimed is:

1. A luminous device for an automotive vehicle, for projecting an image onto the ground around the automotive vehicle, the luminous device comprising:
a light source,
a slide provided with at least one pattern, the at least one pattern being arranged in such a way as to be lit up by the light source, and
at least one mask provided with an opaque zone, the mask being movable between a first position and a second position relative to the slide,
the opaque zone of the mask not extending across a light beam coming from the slide when the mask is in the first position so as to project a first image onto the ground, and
the opaque zone of the mask extending across the light beam coming from the slide when the mask is in the second position so as to project a second image onto the ground that is different to the first image.

2. The luminous device as claimed in claim 1, further comprising a first stop means defining the first position of the mask and/or a second stop means defining the second position of the mask.

3. The luminous device as claimed in claim 1, further comprising an actuator configured to move the mask in translation between its the first position and the second position.

4. The luminous device as claimed in claim 3, wherein:
the actuator includes an electromagnet, and the mask includes an element made of ferromagnetic material configured to interact with the electromagnet, or in that
the actuator includes a motor provided with a pinion, the mask including teeth interacting with the pinion.

5. The luminous device as claimed in claim 1, wherein the at least one pattern of the slide includes at least one opaque zone and at least one transparent zone, the opaque zone of the mask includes a shape substantially homothetic to the shape of the at least one transparent zone of the slide to occult the at least one transparent zone of the slide when the mask is in the second position.

6. The luminous device as claimed in claim 1, wherein the at least one pattern of the slide includes an opaque zone, a first transparent zone, and a second transparent zone, the second transparent zone being separated from the first transparent zone by the opaque zone of the slide, the mask includes a transparent zone extending opposite the first transparent zone of the slide and the opaque zone of the mask extending opposite the second transparent zone of the slide when the mask is in the second position.

7. The luminous device as claimed in claim 1, further comprising:
a first mask provided with an opaque zone, the first mask being movable between a first position and a second position relative to the slide, and
at least one second mask provided with an opaque zone, the second mask being movable between a third position and a fourth position relative to the slide,
the opaque zone of the first mask and the second mask not extending across a light beam coming from the slide when the first mask and the second mask are in the first position and the third position so as to project a first image onto the ground,
the opaque zone of the first mask extending across the light beam coming from the slide when the first mask is in the second position and the second mask is in the third position so as to project a second image onto the ground that is different to the first image, and
the opaque zone of the second mask extending across the light beam coming from the slide when the second mask is in the fourth position so as to project a third image onto the ground that is different to the first image and the second image.

8. The luminous device as claimed in claim 1, wherein the slide includes a first pattern and at least one second pattern, and in that the slide is movable between a first position and a second position, the first pattern being arranged in such a way as to be lit up by the light source when the slide is in the fifth position, the second pattern being arranged in such a way as to be lit up by the light source when the slide is in the sixth position, the luminous device being adapted to project a first image onto the ground when the slide is in the fifth position, and the luminous device being adapted to project a fourth image onto the ground when the slide is in the sixth position.

9. The luminous device as claimed in claim 8, wherein the slide has a generally circular shape, and in that the luminous device includes an actuator configured to rotate the slide between the fifth position and the sixth position about a center of the slide.

10. A method for operating a luminous device as claimed in claim 1, further comprising a movement of the at least one mask from the first position to the second position then a movement of the at least one mask from the second position to the first position to produce a flashing effect of the image projected onto the ground.
